(19) United States
(12) Patent Application Publication
(10) Pub. No.: US 2012/0093644 A1
(43) Pub. Date: Apr. 19, 2012

(54) System and Method for Generating Energy from a Streaming Fluid

(76) Inventor: Erwin Johan Croughs, GP Rotterdam (NL)

(21) Appl. No.: 13/321,234

(22) PCT Filed: May 19, 2010
(86) PCT No.: PCT/NL10/50297

§ 371 Date: Nov. 18, 2011

(30) Foreign Application Priority Data
May 20, 2009 (NL) 10369778
Sep. 24, 2009 (NL) 1037315
Nov. 11, 2009 (NL) 2003790

(51) Int. Cl. F03B 3/12; F01D 5/14

(52) U.S. Cl. 416/1; 416/223 R

(57) ABSTRACT

A system for generating energy from a streaming fluid having a mean streaming direction, comprising a generator and an assembly arranged to be entrained in the streaming fluid and which is moveably connected to a fixed point upstream of the assembly, wherein a generator is arranged to generate energy from movement of the assembly, parallel to and in the same direction as the mean streaming direction, against the fixed point, wherein the assembly comprises at least two interconnected blades, their surfaces extending substantially perpendicular across the mean streaming direction, wherein each of the blades has a conical cross section and a second blade extends at a distance downstream and staggered in a direction perpendicular to the mean streaming direction with respect to a first blade.

The present invention relates to a system and method for generating energy from a streaming fluid. The invention further relates to an assembly for use in such a system or method.

The world is addicted to and needs more fossil fuels every day whereas they become less available at the same rate. The world is waiting for the fossil industry to allow hard commitments for sustainable energy and keeps on waiting. The world is a free market and where expensive wind and solar plants are being build, the need for cost effective and reliable sustainable energy increases along with the awareness that climate change, industrial lobby and future energy dependence are becoming problems of a magnitude greater than anything we have confronted so far. Sustainable high-tech tidal energy converters are on the draw boards and even in use, but simple cheap high yielding slow current converters with virtual unlimited installation possibilities which will easily and economically break the backbone of industry blackmail have not yet appeared on the horizon. Present invention is going for a smart method to generate power with simple slow flow converters and tries to enhance yields by concentrating and increasing the flow that is effectively converted into usable power.

Present invention provides the means, methods, systems, ways of application and use of such a converter, as well as a discussion of workability. It is well known that river, ocean and tidal currents contain large quantities of highly reliable energy. Most effective ways of harnessing the energy is by turbines in dams or in open currents. The first is limited to very specific geographic locations but the last has sheer unlimited potential. The two main types of turbines are those that run along with the current and those that run at a 90 degree angle. The first, Savonius type rotors, generate low power because the working stroke is performed in the same direction as the current, making low relative speeds and thus little energy exchange. The second, moving at an angle of 90 degrees with the flow, get the best results.

The main problem of making open current underwater turbines with sufficient power is pressure leverage on the turbine blades. They either move in the same direction and results are low or they move at 90 degrees and break. The reason engineers insist on countering great ocean forces is the higher return on investment. To withstand the forces new high-tech materials and constructions are invented at high costs. The flaw in logic is of course trying to counter large amounts of concentrated energy instead of using it.

To solve above problems, a system is provided for generating energy from a streaming fluid, in particular water, having a mean streaming direction, comprising a generator and an assembly arranged to be entrained in the streaming fluid and which is moveably connected to a fixed point upstream of the assembly, wherein a generator is arranged to generate energy from movement of the assembly, parallel to and in the same direction as the mean streaming direction, against the fixed point, wherein the assembly comprises at least two interconnected blades, their surfaces extending substantially perpendicular to the mean streaming direction, wherein each of the blades preferably has a conical cross section and a second blade extends at a distance downstream and staggered in a direction perpendicular to the mean streaming direction with respect to a first blade. It is important that the assembly moves in the same direction as the main current so that unexpected great wave forces can easily be avoided by making the assembly move faster in the same direction as the current. This way the difference in velocity between water and assembly lessens and forces on chains, cable, generator and winch lessen as well. It is also important that the assembly is staggered otherwise the blades would be in each other's wake, thereby losing power to generate energy.

The present invention tries to solve the problem of countering great forces while maintaining optimum performance by a forward direction at a straight angle with the flow. The solution is found in changing the direction of the current so that no heavy leverage, no friction, no cavitations and no resistance are countered; instead they're used, generating extra power. It looks like there is hardly any velocity difference between the main current and the machine and from that effect present invention derives its name: The Slow Mill.

According to a further preferred embodiment a system is provided wherein each conical cross section of the blades has an apex, wherein each of the normals on the apices of the blades extend substantially parallel to the mean streaming direction. The blades need to be perpendicular to the main current for maximum benefit of the Slow Mill effect caused by optimum angle of impact between flow and blade with respect to the direction of work performed by the blades. They can be flat conical shaped blades or in the form of hydrodynamic wings but the first saves a lot of construction costs.

The term conical as used herein is to be interpreted as a conic section or conic curve. The apex is a local maximum of said curve. Preferably, the blades have a substantially parabolic cross section. Highest efficiency is gained when the blades are symmetrical so that the water hits both sides of the apex equally, thereby stabilizing the assembly and transferring energy effectively.

According to a further preferred embodiment, each blade is connected to the next by connectors that are at least as long as and at most three times as long as the shortest side of the blades. If the blades are placed too close to each other the water will flow around the assembly and if they are placed too far apart the energy will be less concentrated as relatively less water will meet barriers that have to be circumvented and thus less concentrated water will be captured by the next blade.

According to a further preferred embodiment, the line through the ends of the conical cross section of a blade forms an angle between 30 degrees and 60 degrees with the tangent of the blade in the end of the conical cross section. During testing several curves were tried. A flat blade is not stable and has little resistance. A half pipe has a relative small surface exposed to the current and water flowing into a half pipe can't easily exit, thus stopping the flow. In between these we find the optimum blade performance.

According to a further preferred embodiment, connecting means between the upper part of a downstream blade and the lower part of an upstream blade, are arranged to vary the distance between said parts. A problem of the recovery stroke is that the blades are either pushed to the water surface and are difficult to reel in towards a lower point due to the resisting current flowing underneath them or when flipped the other way the current moves them directly to the bottom so that lots of friction with sand results while reeling in. To solve this, the blades get connected to each other so that they can be moved more or less in one line with the anchor point so that the assembly can be controlled to float between surface and bottom. In that position the resistance during reeling in will be substantially less.

The invention further relates to an assembly comprising at least two interconnected blades, wherein each of the blades has a conical cross section having an apex, wherein a second blade extends at a distance from the first blade in a direction of the normal on the apex of the first blade, wherein the second blade further extends staggered in a direction perpendicular to said normal and wherein each of the normals on the apices of the blades extend substantially parallel. Water flowing into the hollow side of a conical blade needs to equally easy flow out to not stop the flow behind it and allow continued impact of water to keep the assembly performing work. Above the apex the water will push the blade upwards and forward, below the apex the water will push the blade downwards and forward. The resulting vector on a symmetrical blade will be forward, while lots of energy gets transferred from the current to the blade. The main current above the blade gets concentrated by the water that is trying to circumvent the blade that acts as a barrier.

Both streams are captured by the next blade which is rigged the same way but staggered above the first one to optimally capture that flow. This mechanism concentrates the energy of the main current and transfers it effectively onto the assembly.

Preferably an assembly is provided, comprising at least two interconnected blades that in operating condition extend substantially perpendicular to the main direction of the current with the second blade downstream and staggered in a direction straight at the main direction of the current in relation to the first blade. The system enhances energy transfer and obtains good stabilisation and increases the amount of current flow passing through and thus gains more energy. It looks like a multiple kite assembly but it is suspended under water and it has straight angles with the current; a kite would come down at such angles. It is based on the Slow Mill Effect: enhancing energy transfer of a current flowing straight at a barrier by creating high and a low energy potential area's in front of the barrier to deflect the flow and maintaining this to continue enhanced energy transfer. Because a current easily circumvents obstacles, especially as they move in the same direction, usually a lot of energy gets lost. To get more energy out of the current, the blades are positioned as in above assembly.

The current flows over a blade, hits the next blade, transfers energy, flows down to the low potential behind the first blade, goes down further and discharges into the undercurrent beneath the assembly. To increase the energy out of the current, the blades not only convey energy onto the cable but are positioned so as to direct the overflow, which usually gets lost, onto the next blade behind and above it. The directed flow has more pressure and speed and thus more energy can be extracted by the next blade that does the same to the next one. The upstream blades create a low potential behind them where the current is deflected into. The deflection creates a flow at a 90 degree angle with the forward direction of the next blade where lots of energy can be exchanged. Behind that blade water must also travel a greater distance and a low potential is created as well, causing a greater resulting force on it and the same effect at the next blade.

If the tops of the blades lean a bit against the direction of the flow, the machine will start swaying left to right as the flow, seeking the shortest way, will dive under, left or right of the blades. If the tops of the blades fall a little in the direction of the flow, the machine will oscillate up and down as more water flows over the blades and the machine can't stay stably afloat. Both will decrease the generated power as the ideal impact gets disrupted.

The construction may look like an assembly of kites generating energy but that operates by lift and can't stay at a straight angle with the wind as downward forces of the cable and weight will pull it down. Kites produce optimum work in near vertical direction and need great distance between them to not interrupt the current, whereas the Slow Mill has its blades at close intervals to concentrate and deflect the current.

According to a preferred embodiment the assembly has a plurality of blades in which each following blade is positioned downstream, parallel and staggered in a direction straight at the main direction of the current, in relation to prior blades. Multiple blades are situated behind and above each other at such a distance that the lower ones, concentrating the energy of the current, can pass that to the blades above and behind them. The blades are staggered to collect a great surface of current flow; those downstream shouldn't be in the wake of the ones upstream and are positioned substantially above them to receive full flow. Right behind every blade a spot with low potential is created and the high energy current will flow towards it. It will pass the next higher blade in doing so with high velocity due to the concentrated energy and deflected flow caused by the potential difference. Thus the current can transfer a great amount of energy onto the higher blade. Only the first blade will have low yields but each next blade will benefit from the previous one and thus a plurality of blades gives best results.

According to a further preferred embodiment the blades are interconnected by cables, chains or ropes and to a mechanism that controls the angle of the blades with the current by varying their lengths. Like a kite the blades are pulled by the current and when their lower parts turn back, they'll rise and when their upper parts pull back, they'll come down.

According to a further preferred embodiment the blades are curved lengthwise so they have two straight sides; the line connecting them makes an angle between 30 degrees and 60 degrees with the surface that is formed when the blade is flat. In physics it is known that curved blades have greater resistance to a flow than flat blades. Because the flow on the backside travels a greater distance, lower pressure is created there.

According to a further preferred embodiment, the hollow sides of the blades face in working position upstream to deflect the current, usually downward.

According to a further preferred embodiment the distance between the blades in working position is at the most three times the shortest side of the upstream blade. The length of the chains that connect the blades needs to be at least as long as the width of the blades, and at the most three times longer but preferably two times, in order to have enough flow pass between the blades so that good energy transfer can take place. If that space is too small the current gets too much resistance and seeks a way around the assembly and yields will drop. If that space is more than three times the width of the blades, yields also drop as not enough energy gets concentrated.

According to a further preferred embodiment the blades comprise hydrodynamic wings or sails. It is known that wings perform very well, especially when they move in a different direction than the current.

According to a further preferred embodiment, the assembly comprises a floating body. In use, the assembly is held at least partly in suspension in the medium, whether it is flowing or not, by a body that is lighter than water and heavier than air that is only connected to the assembly. When there is good current and the blades are a little slanted the assembly can be held in place by lift but when the blades are at a straight angle with the current, they won't have lift and tend to sink. Also, when there is no current, lift is impossible. So there should always be another force to get the assembly suspended in the medium and that is provided by a floating body connected to the assembly or blades at least partly lighter than water. If it can only take part of the assembly up into the medium, flow can lift the rest.

According to a further preferred embodiment the blades can be varied; a working condition wherein they are extended substantially at a 90 degree angle with the main flow direction and a returning position wherein they extend substantially in the direction of the anchor point. To get most resistance during the work stroke, maximum surface is exposed to the current but to return to the starting position a minimum of resistance is required and the blades are flipped in the direction of the anchor so that the current actively pushes them down.

According to a further preferred embodiment the generator converts mechanic energy from the assembly into a fluid under pressure. A pump can pressurise a medium and transport the energy to a point where it can be processed. It doesn't need a lot of maintenance or repair and is cheaper than a generator on the bottom of the sea. There will be transport losses but a power plant on land has many advantages for construction, personnel, repair, life years, etc.

According to a further preferred embodiment the generator is connected to a winch at the anchor point. To facilitate the connection to the shore or grid, the generator is placed on the seabed.

According to a further preferred embodiment the generator is connected to a winch at the assembly. To avoid installing expensive generators on the ocean floor, the generator is attached to the assembly and is easy to replace.

According to a further preferred embodiment the generator determines the speed and direction between assembly and anchor point by directing more or less energy to or from a point where energy is processed. To generate power the assembly needs to move along the current and roll off the winch that is resisted by a generator or pump. For each speed of current there is an optimum speed at which the assembly generates optimum power. A computer calculates how much resistance is needed and adjusts the amount of resistance. Resistance is higher when more power is depleted. So speed and power generation can be maintained at an optimum ratio. At the end of the work stroke the computer turns the blades in the current what turns off the pressure and the generator becomes a motor that reels in the assembly at resistance.

According to a further preferred embodiment at least part of the assembly has a ratio of mass to volume that is lower than that of water. The system can be held in place by several means. A separate body may not be optimum because of the drag during the recovery stroke. Air is a good medium to fill up hydrofoils and a partly floating construction can easily be made and the system will always be operable and no energy is wasted on lifting. Risks of coming down are small, can easily be countered and don't have grave effects. The assembly should stay suspended so it can move along with changing currents but it can't float too much as recovery will cost more energy.

The invention furthermore relates to a method for generating energy from a streaming fluid, in particular water, having a mean streaming direction, from movement between a fixed point and an assembly arranged to be entrained in the same direction as and parallel to the mean streaming direction from a starting location to a returning location, wherein the assembly comprises at least two interconnected blades, preferably having conical cross sections, wherein a second blade extends downstream with respect to a first blade, wherein the blades are movable between a working position and a returning position, wherein in the working position the blade surfaces extend substantially perpendicular to the mean streaming direction, the second blade extending staggered in a direction perpendicular to the mean streaming direction with respect to the first blade, wherein in the returning position the blades extend substantially in a plane through the fixed point, the method comprising the steps of:
moving the blades to the working position at the starting location;
entraining the assembly, moving the blades in the direction of and parallel to the mean streaming direction, thereby generating energy from that movement against the fixed point;
moving the blades to the returning position at the returning location, and;
returning the assembly to the starting position.

This method of generating energy from currents and waves is highly effective compared to contemporary converters because it reduces the biggest problem they have to an absolute minimum. The biggest problems with ocean energy are the huge forces that smash constructions to smithereens and the high friction, limiting their size. Because present invention is arranged to move in the same direction as the great forces, it doesn't need to hold up against them thereby eliminating the great force problems. Also the problem of friction is brought down to an absolute minimum. During the work stroke there is almost no friction due to aligned movement of water and assembly. During the recovery stroke there is some friction but it is brought down to a minimum by flipping the blades nearly parallel to the flow direction. As brakes are not necessary, there will not be great stresses on the cable nor assembly. The parts and amounts of steel used are brought down to a minimum as the construction does not need to withstand extreme wave forces nor high friction. A Slow Mill of 6 MW can be transported in 2 sea containers. Of all other kinds of sustainable energy, probably only waterfalls with natural high lakes to replace reservoirs will need less installed weight per kilowatt.

To perform work the assembly is moved by the current and a cable connected to the anchor point is reeled off. When the cable is pulled out at the end of the work stroke, the assembly needs to be reset and that is done by flipping the blades in the direction of the current so that resistance is minimum and then applying power to the generator or pump that becomes a motor and reels in the cable so that the device returns to its starting point and repeats the work stroke. To adjust the position of the blades, a device connected to a movement sensor and control unit, shortens and lengthens the monitor chains a bit to maintain optimum angles across the current to stabilize and optimize operation. To recover the assembly to its starting position the device can lengthen the lower chains, aligning the blades in the direction of the current, losing resistance and the chain is pulled in, partly by current pressure, to its starting point where the blades are set straight across the current and the work cycle starts again.

According to a further preferred embodiment the assembly is kept substantially parallel to the main direction of the current by a floating body so net effective work is generated substantially parallel to and in direction of the main direction of the current. Of course it will fluctuate a bit up and down but no net work will come from the oscillation. Kites that have similar features and workability in air cannot perform work in horizontal direction as that requires an angle of 90 degree of the kite with the main direction of the wind and they will come down. Also performance will drop when moving in the same direction as the wind. Only when held up by a pole and put close to each other according to present invention will they keep performing well in horizontal direction.

According to a further preferred embodiment the length of at least two cables, connected to the anchor point and at the other side to the tops of the blades, can be varied against the length of at least two other cables, connected to the anchor point and at the other side to the bottoms of the blades; thus the angle the blades make with the current can be varied.

According to a further preferred embodiment a sensor measures the angle of the blades and is connected to a mechanism that uses the information to adjust the blades to a 90 degree angle with the main direction of the current. The best performance is gotten from a 90 degree angle and it needs adjustment as the angle with the anchor point is not always the same.

According to a further preferred embodiment a computer executes the recovery stroke at least twice as fast as the work stroke. To increase the amount of power generated by the working surface of the blades per time unit, the period of work must be longer than the recovery period. The better the work/recovery ratio, the higher the yields, preferably 4:1.

According to a further preferred embodiment sensors that measure waves are connected to a computer that monitors the optimum position of the blades for generating work during the wave; the sensors measure a wave trough, give that information to the computer that executes the recovery stroke, i.e. returning the assembly, in the wave trough; repetition of the cycle. Waves have lots of energy and many wave converters are engineered but only the bobbing buoy performs somewhat as most other devices break in storms. They have the same problem as all resistance devices that are circumvented by currents so that only small parts of the energy contained in the waves can be harnessed. State of the art wave devices are constructed to generate energy out of the surface waves but said assembly also uses wave energy contained 10 or 20 meters underneath, which is much more than the surface energy. It has the full wave flow through and can endure storms suspended under the rough surface. A computer lets the work stroke roll along the wave and the recovery stroke in the wave trough that already has a tendency to flow back and thus less energy is consumed during recovery. Sensors that are connected to the computer provide data as to the optimum timing of work and recovery strokes.

According to a further preferred embodiment a propeller or jet has at least part of the assembly floating in said medium. If the assembly is too heavy and sinks to the seabed, a mechanical force can lift it up into the medium. The current can than push it further into working position.

The present invention is further illustrated by the following Figures, which show a preferred embodiment of the device according to the invention, and are not intended to limit the scope of the invention in any way, wherein:

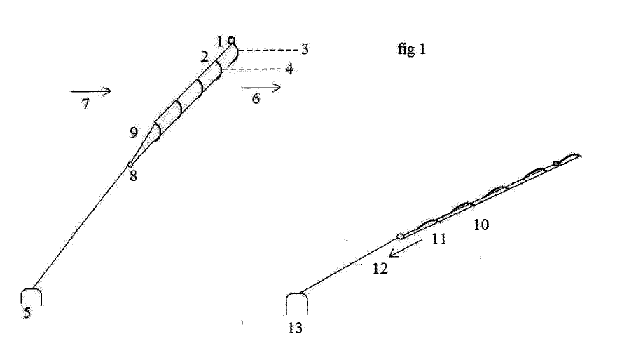

FIG. 1 schematically shows the system according to the invention in both the working as the returning position;

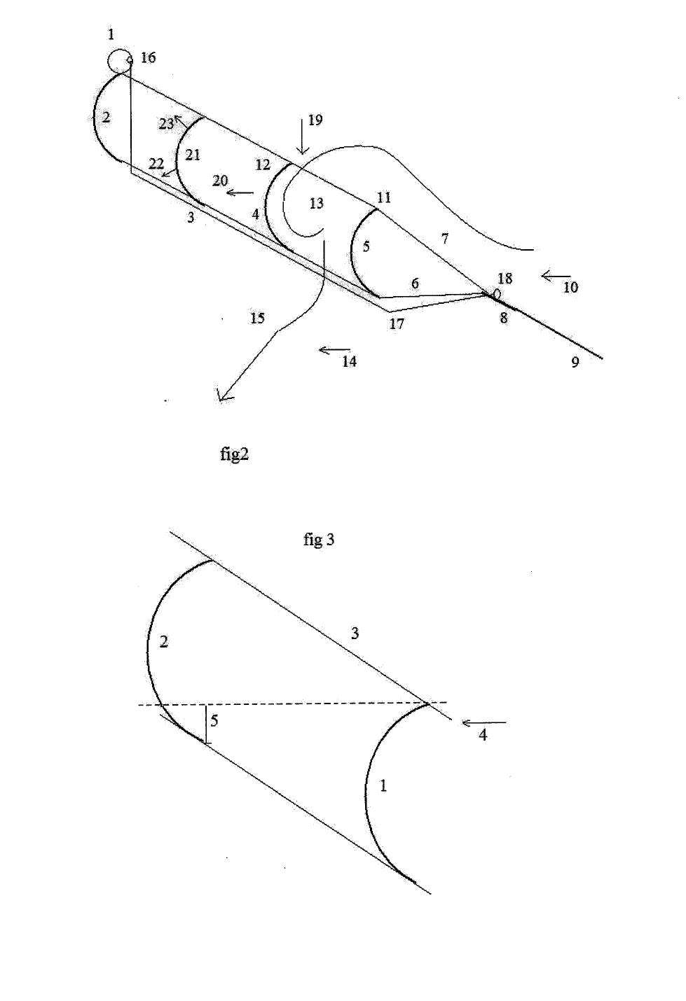

FIG. 2 schematically shows the system and method of the assembly concentrating and transferring energy from currents;

FIG. 3 schematically shows the relationship between the blades of the assembly and how they overlap;

FIG. 4 schematically shows the relative distances of the blades.

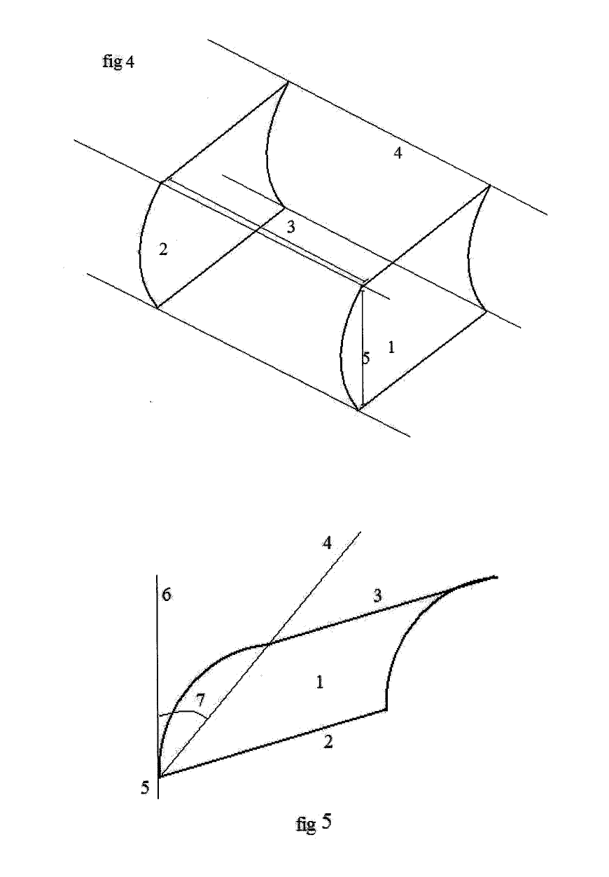

FIG. 5 schematically shows the curvature of the surface of a blade.

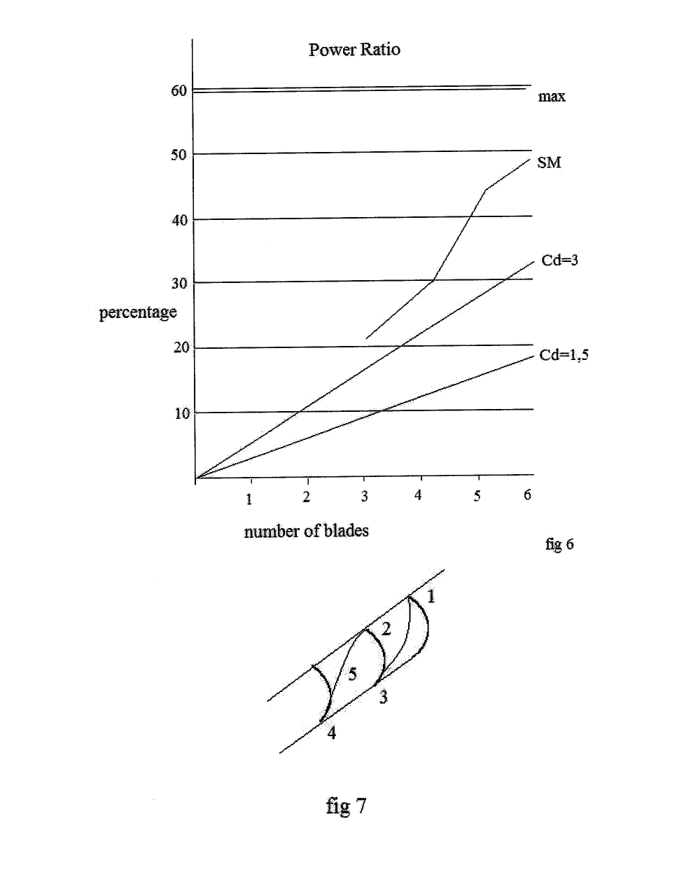

FIG. 6. shows the graph results of the tests at TU Delft.

FIG. 7. schematically shows a way of interconnecting the blades according to the invention, and;

In FIG. 1, blades (1,2) are parallel and staggered, their normals (3,4) are also parallel and staggered. The assembly is connected to anchor point (5) and moves (6) in the same direction as the main current (7). Mechanism (8) varies the relative length of cables (9) and the blades (10, 11) turn into the direction of the anchor point (13) and move (12) towards it.

In FIG. 2, on a floating body (1) hang blades (2,3,4,5) which are connected through monitor chains (6,7) to monitor frame (8) which is connected to the seabed by cable (9). The current (10) flows straight at blade (5) which resists it and diverts the flow partly over its top (11) thus concentrating the energy of it, to be captured at blade (4). Behind blade (5) is an area of low potential (13) as no straight flow can get there; the water travels a greater distance. The current (14) that flows under the machine sucks (15) the energy starved flow into its stream. On the floater (1) is a movement measuring device (16) which is connected by cable (17) to a control unit (18) on monitor frame (8). When it measures too much movement up and down the control unit pulls monitor chain (7) and when it measures too much swaying left and right, the control unit pulls monitor chain (6) to stabilize the machine. At the end of a working stroke the control unit slackens chain (6) so that the blades follow the direction of current flow (10), losing their resistance so that cable (9) can pull the machine back to its starting position. At the top (12) of blade (4) the current comes partly in vertical (19) direction onto the blade. A lot of energy is exchanged because the direction of the blade makes an optimum angle with the deflected flow. The part of the surface above the apex (21) of a blade will be pushed up and forwards (23), the part below the apex gets pushed down and forwards (22). The resulting vector (20) is responsible for the work of the assembly in horizontal direction after maximum energy is transferred.

As shown in FIG. 3, blades (1,2) are connected by cables (3). Blade (2) is behind, parallel and staggered with regards to blade (1), overlapping it 25% (5) in the mean streaming direction (4).

As shown in FIG. 4, blades (1,2) are connected by cables (4) least as long (3) as the smallest side (5) of a blade (1) and maximally three times as long.

As shown in FIG. 5, blade (1) has a conical cross section and the line (4) that connects their ends (2,3) crosses the tangent (6) in an end of the cross section (5) at an angle of at least 30 degrees (7) and at most 60 degrees. Optimum angle at 45 degrees.

Shown in FIG. 6 is the graph of the tests results in TU Delft, the generated power of the Slow Mill doesn't move linear when more blades are placed in the same current area and it exceeds expected results of a single body in a current.

As shown in FIG. 7, upper parts (1,2) of upper blades are connected to lower parts (3,4) of lower blades by connecting means (5) that can vary the distance between said parts.

In September 2009 an experiment was conducted at the Fluid Mechanics Laboratory of the Delft University of Technology. A small test model of the Slow Mill with 5 blades of 8 cm×40 cm was hooked onto a movable Newton meter and put in a laboratory testing current of 20 cm/s. Normally a body in a stream has a resistance coefficient Cd of around 1.5 and generates an optimum of about 20% of the available energy in the current.

An object in a water current experiences a force Fd that can be defined by Fd=½ [symbol] ACdVr²

Where:

[symbol] =water density=1000 kg/m³;

A=flow surface;

Vr=Vw-Vv=relative speed of the object Vv with regard to the waterspeed Vw;

Cd=resistance coefficient of the object;

The power that can be generated by the object is:

Pv=FdVv=½ z,21 ACd Vr²Vv=½ [symbol] ACd (Vw-Vv)²Vv

The power that is available in the water is:

Pw=½ [symbol] AVw³

Efficiency of the object is:

Pv/Pw=Cd Vv/Vw

The theoretical absolute maximum efficiency is reached at:

Vv=⅓Vw

Thus the theoretical maximum efficiency of the object is: ⅓ Cd.

This is practically unobtainable and still pretty low because the body and current have the same direction, making low relative speeds and on top of that a great deal of the current circumvents the body. But the model generated during the work stroke about 48% of the available energy. The power was more than expected, see FIG. 6 under SM, and even more than high-tech windmills, which do about 44%. The theoretical maximum that can be generated from currents, the Betz Limit, is 59.3%. It did not need to be very refined because friction and leverage that windmills compensate, costing efficiency, were captured by the cable and Newton meter, adding to the generated work. The optimum speed at which a single body generates most energy is ⅓^{rd} of the water velocity but the Slow Mill performed optimum at ⅗^{th} of the water velocity, proving it not to act like a single body.

So the Slow Mill cannot be seen as a single body resisting a current. The only known way to reach the high results is at high relative speeds between current and blades and is optimum at an angle of about 90 degrees. Because the blades are situated behind and above each other, the direction of flow is changed and hits the blades in vertical direction. The vertical speed of the blades is zero and high relative speeds are created. Above change of direction and impact was plainly visible in a coloured water flow used for visualisation of currents. The number of blades influenced the generated amount of work. When more blades are put in the same flow surface, the power per blade increases significantly, proving the leverage they have on each other. The blades performed best perpendicular to the main direction of the current, proving that the current got deflected. The same assembly performed significantly less when gaps between blades were closed partly, proving that a good flow between blades is needed for high efficiency. Above thesis also got proved by photo and video material of coloured water streams rolling through the blades.

The present invention is not limited to the embodiment shown, but extends also to other embodiments falling within the scope of the appended claims.

1. A system for generating energy from a streaming fluid having a mean streaming direction, comprising a generator and an assembly arranged to be entrained in the streaming fluid and which is moveably connected to a fixed point upstream of the assembly, wherein a generator is arranged to generate energy from movement of the assembly, parallel to and in the same direction as the mean streaming direction, against the fixed point, wherein the assembly comprises at least two interconnected blades, their surfaces extending substantially perpendicular to the mean streaming direction, wherein each of the blades has a conical cross section and a second blade extends at a distance downstream and staggered in a direction perpendicular to the mean streaming direction with respect to a first blade.

2. The system according to claim 1, wherein each conical cross section of the blades has an apex, wherein each of the normals on the apices of the blades extend substantially parallel to the mean streaming direction.

3. The system according to claim 1, wherein the blades have a substantially parabolic cross section.

4. The system according to claim 1, wherein each following blade overlaps the previous one not more than 25% in the mean streaming direction.

5. The system according to claim 1, wherein each blade is connected to the next by connectors that are at least as long as and at most three times as long as the shortest side of the blades.

6. The system according to claim 1, wherein the line through the ends of the conical cross section of a blade forms an angle between 30 degrees and 60 degrees with the tangent of the blade in an end of the conical cross section.

7. The system according to claim 1, wherein connecting means between the upper part of a downstream blade and the lower part of an upstream blade, are arranged to vary the distance between said parts.

8. An assembly for use in the system according to claim 1, comprising at least two interconnected blades, wherein each of the blades has a conical cross section having an apex, wherein a second blade extends at a distance from a first blade in a direction of the normal on the apex of the first blade, wherein the second blade further extends staggered in a direction perpendicular to said normal and wherein each of the normals on the apices of the blades extend substantially parallel.

9. A method for generating energy from a streaming fiuid having a mean streaming direction, from movement between a fixed point and an assembly arranged to be entrained in the same direction as and parallel to the mean streaming direction from a starting location to a returning location, wherein the assembly comprises at least two interconnected blades having conical cross sections, wherein a second blade extends downstream with respect to a first blade, wherein the blades are movable between a working position and a returning position, wherein in the working position the blade surfaces extend substantially perpendicular to the mean streaming direction, the second blade extending staggered in a direction perpendicular to the mean streaming direction with respect to the first blade, wherein in the returning position the blades extend substantially in a plane through the fixed point, the method comprising:
moving the blades to the working position at the starting location;
entraining the assembly, moving the blades in the direction of and parallel to the mean streaming direction, thereby generating energy from that movement against the fixed point;
moving the blades to the returning position at the returning location; and
returning the assembly to the starting position.

10. The method for generating energy according to claim 9, wherein a control mechanism executes the return movement at least twice as fast as the working stroke.

11. The method for generating energy according to claim 9, wherein sensors measure waves and give that data to a computer that places the blades in optimum position to harness the waves; the sensors measuring the wave retreat and give that data to the computer that executes the return movement.

12. The method for generating energy according to claim 9, wherein a propeller, buoyant body and/or jet makes at least part of said assembly float.

13. The system according to claim 2, wherein the blades have a substantially parabolic cross section.

14. The system according to claim 2, wherein each following blade overlaps the previous one not more than 25% in the mean streaming direction.

15. The system according to claim 3, wherein each following blade overlaps the previous one not more than 25% in the mean streaming direction.

16. The system according to claim 2, wherein each blade is connected to the next by connectors that are at least as long as and at most three times as long as the shortest side of the blades.

17. The system according to claim 3, wherein each blade is connected to the next by connectors that are at least as long as and at most three times as long as the shortest side of the blades.

18. The system according to claim 4, wherein each blade is connected to the next by connectors that are at least as long as and at most three times as long as the shortest side of the blades.

19. The method for generating energy according to claim 10, wherein sensors measure waves and give that data to a computer that places the blades in optimum position to harness the waves; the sensors measuring the wave retreat and give that data to the computer that executes the return movement.

20. The method for generating energy according to claim 10, wherein a propeller, buoyant body and/or jet makes at least part of said assembly float.
